(19) United States
(12) Patent Application Publication
(10) Pub. No.: US 2021/0127704 A1
(43) Pub. Date: May 6, 2021

(54) EDIBLE FLOATING BALLOON CONFECTION

(71) Applicant: Michael Edward Bagale, East Hampton, NY (US)

(72) Inventor: Michael Edward Bagale, East Hampton, NY (US)

(21) Appl. No.: 16/670,507

(22) Filed: Oct. 31, 2019

(51) Int. Cl. A23G 3/42; A23G 3/36; A23G 3/34

(52) U.S. Cl. CPC A23G 3/42; A23G 3/368; A23V 2002/00; A23G 3/0097; A23G 3/343

(57) ABSTRACT

An edible floating balloon composition and method of making the same. The edible floating balloon composition includes blending water with a hydrocolloid such as methylcellulose and xanthan gum to form a gelling solution. The gelling solution is vacuum packed in a container and refrigerated until the hydrocolloid is fully bloomed. An isomalt melt is then prepared. The gelling solution and a liquid glucose are mixed to form a gellification solution. The gellification solution is tempered into the isomalt melt to form an edible balloon taffy. One or more of an ascorbic acid and a citric acid are mixed with the edible balloon taffy. Optionally, a flavoring element is added to the edible balloon taffy. A pressurized gas may be injected into the edible balloon taffy to form a balloon of a desired size. The pressurized gas may be helium so that the balloon may float.

### BACKGROUND OF THE INVENTION

The present invention relates to edible confections and, more particularly, to edible floating balloon confections.

In making edible confections, it is desirable for the confection to be provided with a pleasing and appetizing appearance. In other instances, it may be desirable to form the confection so that it carries a theme for a particular event or occasion. An edible floating balloon confection would provide festive treat.

Previous attempts to create a floating balloon confection included the use of gelatin and agar. The inventor has discovered that gelatin produces a balloon with a very temporary shelf life. Moreover, the confection had a very sticky texture and was not ideal for consumption.

As can be seen, there is a need for a method for producing an improved floating balloon confection.

### SUMMARY OF THE INVENTION

In one aspect of the present invention, an edible balloon composition is disclosed. The edible balloon composition includes a gelling solution formed by a mixture of methylcellulose, xanthan gum and water; an isomalt melt, consisting of molten isomalt; and a liquid glucose. The preferably, the gelling solution includes 25 grams of methocullulose F50, 25 grams of xanthan gum, and 110 grams of water. The isomalt melt may include 1025 grams of isomalt and 160 grams of the liquid glucose. The edible balloon composition may also include 20 grams of ascorbic acid or citric acid. Optionally, the edible balloon composition includes 5 grams of a flavoring agent.

In other aspects of the invention, a method of making an edible balloon is disclosed. The method includes blending water with a methylcellulose and a xanthan gum to form a gelling solution. The gelling solution is vacuum packing in a container and refrigerated until the metholcellulose and xanthan gum are fully bloomed. An isomalt melt is prepared.

The gelling solution is mixed with a liquid glucose to form a gellification solution. The gelification solution is tempered into the isomalt melt to form an edible balloon taffy. One or more of an ascorbic acid and a citric acid are mixed with the edible balloon taffy.

In a preferred embodiment, the gelling solution further comprises 1100 grams of water, 25 grams of methocellulose F50, and 25 grams of xanthan gum. The isomalt melt includes 1025 grams of isomalt.

The gellification solution may include 160 grams of the gelling solution and 160 grams of the liquid glucose. Preferably, the gellification solution is mixed until it is a homogenous mixture.

In some embodiments of the method, the tempering includes sequentially mixing portions of the gellification solution into the isomalt melt.

In yet other embodiments, the method includes mixing 20 grams of the one or more of the ascorbic acid and the citric acid, mixed over a low heat.

The method may also include mixing 5 grams of a flavoring agent with the edible balloon taffy over a low heat.

In yet other embodiments, the method includes injecting a pressurized gas into the edible balloon taffy; and inflating the edible balloon taffy to a spheroidal body. In preferred embodiments, the pressurized gas is helium.

The method may also include sealing the spheroidal body to contain the pressurized gas.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a floating balloon confection.

FIG. 2 is a section view of the floating balloon, taken along line 2-2 in Fig.1

FIG. 3 is a flow chart for preparing the floating balloon confection.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

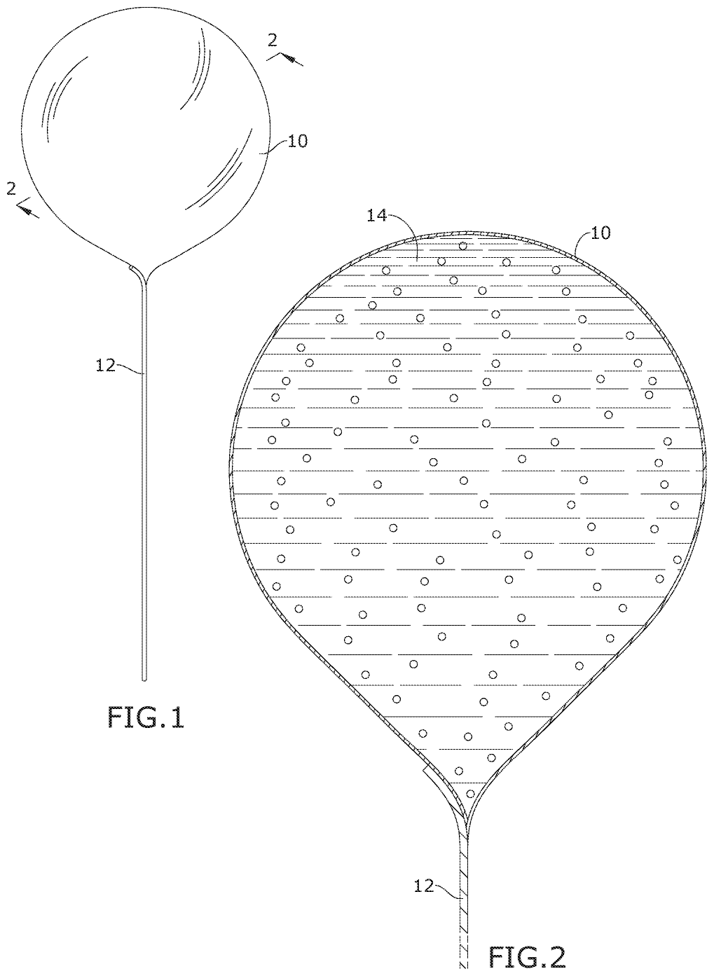

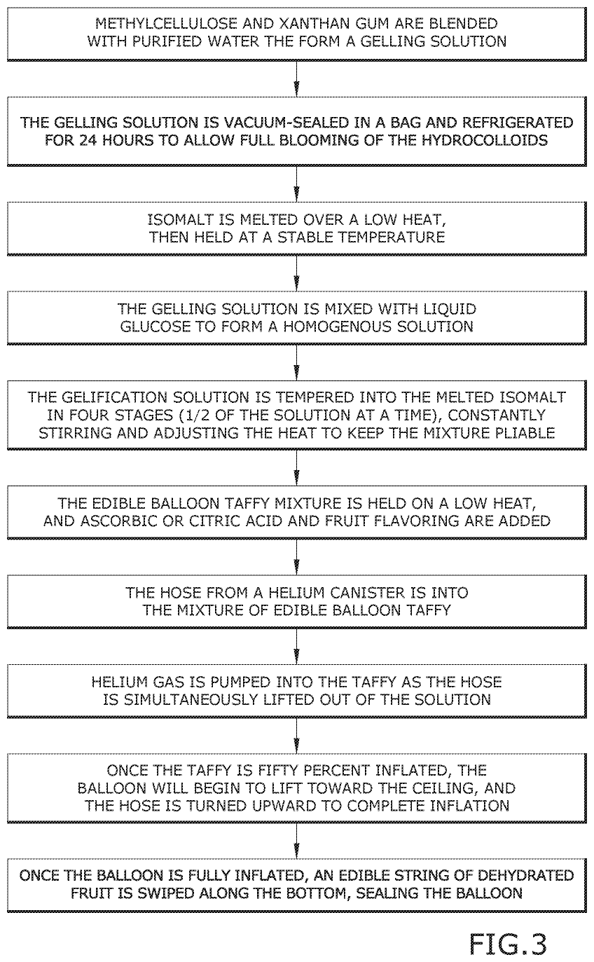

Broadly, an embodiment of the present invention provides a floating balloon confection and a method of making the same. As seen in reference to FIGS. 1 and 2, a floating balloon confection according to aspects of the present invention is shown. The floating balloon confection includes an inflatable balloon 10 that is formed of an elastic confection material. The elastic confection material may be inflated with a source of pressurized helium so that the elastic confection material is expanded into an inflated condition. A desired quantity of helium is filled to overcome the weight of the elastic confection material such that the expanded confection material floats like a balloon.

The expanded confection material may be sealed by the self adhesive properties of the elastic confection material to retain the quantity of helium within the interior of the balloon. A string element 12 may be adhered or tied to a base of the balloon to tether the confection balloon 10. Preferably, the string element 12 is formed of an edible material, such as a dehydrated fruit string.

A method of forming the elastic confection material and forming it as a floating confection is described in the following.

A mixture of methylcellulose and xanthan gum are blended with purified water to form a gelling solution. A preferred recipe for the gelling solution includes combination of 1100 grams of purified water to an immersion blender. The blender is turned on a low speed to create a vortex. With the vortex running slowly sift in 25 grams Methocelluose F50 and 25 grams of xanthan gum. The water will thicken considerably. Once the gelling ingredients are fully blended into the water, the compound gelling agent may be removed from the blender using a rubber spatula. The gelling agent may transferred into a cryovac bag or container and place under a vacuum sealing machine. The air is then evacuated from the bag under vacuum, to compound the gelling agent and allow for consistent hydration. Place the bag of gelling agent in the refrigerator at 32 degrees F., for 24 hours to allow the hydrocolloids to fully absorb the water and reach their full gelling potential.

An isomalt melting is then prepared. The isomalt melting is formed by placing 1025 grams of isomalt into a shallow rondeau or cooking pot and gently melting over a low heat on a heating element, such as an induction burner. Once the isomalt is fully melted, the isomalt melting is retained at a stable low temperature while preparing step 3. is melted over a low heat, then held at a stable temperature.

In a next step the gelling solution is mixed with glucose by combining 160 grams of the gelling solution into a mixing bowl and 160 grams of liquid glucose. The gelling solution and glucose are mixed well, such as with a rubber spatula until it is completely homogenous. The inverted glucose sugar acts as a buffer between the hot isomalt sugar and the tempering of the gelification solution.

In a next step, tempering of gelification/making the edible balloon, is completed. Using a heavy rubber spatula mix/temper the gelification solution into the hot isomalt mixture, preferably in 4 separate steps. In this step, add ¼ of the gelification solution to the pot of isomalt and stir quickly and evenly. The tempering process will release steam as the water in the solution reacts to the hot sugar. This process is important as it concentrates in mixing the gelling agents and the isomalt, which again, is the catalyst for making the balloon flexible and stable.

Continue to mix the remaining ¾ gelling solution ¼ at a time. This gradual process allows the sugar and solution to temper evenly and allow the sugar to continue to absorb the gelling agent while emulsifying with the remaining water. This process is done through constant stirring. If the isomalt, at any point begins to stiffen due to the tempering process, increase the heat slightly to allow the solution to warm again, making it more pliable. Once all the gelling solution has been incorporated, hold the “edible balloon taffy” solution on medium low heat and add 20 grams of ascorbic acid or citric acid, and optionally, 5 grams of a natural fruit flavoring. Stir well until the acid and flavoring are incorporated into the mixture.

To form the floating edible confection, attach a vinyl hosing tube approx. 3.5 feet to a cylinder of helium gas. Once connected, turn on the gas valve and insert the hosing into the pot of edible balloon taffy. Continue to inject the helium gas into the edible balloon taffy, while simultaneously lifting the hosing out of the sugar. This begins the inflation of taffy. Once the taffy is 50 percent inflated, the helium with urge the balloon to lift towards the ceiling. At this point, the hosing may be turned to face upwardly and finish filling the balloon with the desired amount of helium.

A second person may be needed to “catch” the edible balloon confection. This person may use an edible string of dehydrated fruit to swipe the bottom of the inflated confection balloon, and seal the balloon attached to the string.

It should be understood, of course, that the foregoing relates to exemplary embodiments of the invention and that modifications may be made without departing from the spirit and scope of the invention as set forth in the following claims.

What is claimed is:

1. An edible balloon composition, comprising:
a gelling solution formed by a mixture an edible hydrocolloid selected from the group consisting of metholcellulose and xanthan gum with water;
an isomalt melt, consisting of molten isomalt; and
a liquid glucose.

2. The edible balloon composition of claim 1, further comprising:
25 grams of methocullulose F50, 25 grams of xanthan gum, and 110 grams of water.

3. The edible balloon composition of claim 2, further comprising:
1025 grams of isomalt.

4. The edible balloon composition of claim 3, further comprising:
160 grams of liquid glucose.

5. The edible balloon composition of claim 4, further comprising:
20 grams of ascorbic acid or citric acid.

6. The edible balloon composition of claim 5, further comprising:
5 grams of a flavoring agent.

7. A method of making an edible balloon, comprising:
blending water with an edible hydrocolloid selected from the group consisting of methylcellulose and xanthan gum, to form a gelling solution;
vacuum packing the gelling solution in a container;
refrigerating the gelling solution until the edible hydrocolloid is fully bloomed;
preparing an isomalt melt;
mixing the gelling solution and a liquid glucose to form a gellification solution;
tempering the gellification solution into the isomalt melt to form an edible balloon taffy; and
mixing one or more of an ascorbic acid and a citric acid with the edible balloon taffy.

8. The method of claim 7, wherein the gelling solution further comprises 1100 grams of water, 25 grams of methocellulose F50, and 25 grams of xanthan gum.

9. The method of claim 8, wherein the isomalt melt further comprises 1025 grams of isomalt.

10. The method of claim 9, wherein the gellification solution further comprises 160 grams of the gelling solution and 160 grams of the liquid glucose.

11. The method of claim 10, wherein the gellification solution is mixed until homogenous.

12. The method of claim 7, wherein the tempering further comprises:
sequentially mixing portions of the gellification solution into the isomalt melt.

13. The method of claim 7, wherein the one or more of the ascorbic acid and the citric acid is 20 grams, mixed over a low heat.

14. The method of claim 7, further comprising:
5 grams of a flavoring agent mixed with the edible balloon taffy over a low heat.

15. The method of claim 7, further comprising:
injecting a pressurized gas into the edible balloon taffy; and
inflating the edible balloon taffy to a spheroidal body.

16. The method of claim 15, wherein the pressurized gas is helium.

17. The method of claim 15, further comprising:
sealing the spheroidal body to contain the pressurized gas.
